(19) United States
(12) Patent Application Publication
(10) Pub. No.: US 2023/0196029 A1
(43) Pub. Date: Jun. 22, 2023

(54) SIGNAL PROCESSING AND REPORTING

(71) Applicant: INTUIT INC., Mountain View, CA (US)

(72) Inventors: Elhanan MISHRAKY, Tel Aviv (IL); Alexander ZHICHAREVICH, Tel Aviv (IL)

(73) Assignee: INTUIT INC., Mountain View, CA (US)

(21) Appl. No.: 17/556,893

(22) Filed: Dec. 20, 2021

(51) Int. Cl. G06F 40/40; G06F 16/35; G06Q 30/02

(52) U.S. Cl. CPC G06F 40/40; G06F 16/355; G06Q 30/0203

(57) ABSTRACT

A processor may generate a cluster of at least two (or any other minimal cluster size) of a plurality of vectors using a density-based clustering algorithm. The generating may include optimizing at least one hyperparameter of the density-based clustering algorithm by minimizing a loss function to increase a cluster count and decrease a cluster variance. The processor may select a vector closest to the center of the cluster as a representative vector.

### BACKGROUND

A large volume of recorded voice data is accumulated on a daily basis. For example, customers can provide direct feedback on dedicated in-product feedback collection user interface or indirectly on external reviews channels. This feedback (and/or other voice data) is often referred to as “voice of customer” (VOC) data. For example, VOC data can be used to understand acceptance of new features, identify customer pain points, spot product friction areas, plan, and more. Due to the immense volume of VOC data that is continually produced, and due to the unpredictable nature of human conversations, downstream processing of VOC data for analysis and/or to drive subsequent processing actions is time consuming at best and, in many cases, results in outputs that are not actionable due to error and/or loss of data integrity or meaning. These problems are at least in part a result of inadequacies with the machine learning (ML) processing used in the downstream processing.

### BRIEF DESCRIPTIONS OF THE DRAWINGS

FIG. 1 shows an example VOC processing and reporting system according to some embodiments of the disclosure.

FIG. 2 shows an example VOC processing and reporting process according to some embodiments of the disclosure.

FIG. 3 shows an example vector generation process according to some embodiments of the disclosure.

FIG. 4 shows an example cluster generation process according to some embodiments of the disclosure.

FIG. 5 shows an example representation generation process according to some embodiments of the disclosure.

FIG. 6 shows a computing device according to some embodiments of the disclosure.

### DETAILED DESCRIPTION OF SEVERAL EMBODIMENTS

Embodiments disclosed herein provide a natural language processing (NLP) based solution to automatically summarize large streams of incoming VOCs by clustering them to semantic groups and surfacing only the top topics per period of interest (e.g., each week). Disclosed embodiments may also summarize each topic, for example by selecting one comment from each group, which enables quicker analysis of the VOC stream. The end result can be a concise digest from all the VOCs for a specific time period.

To that end, embodiments can use a text clustering algorithm and a text selection method to detect the largest clusters of VOCs and select the best verbatim that captures the semantics of each cluster. The text and metadata available on each VOC can be used to transform the VOC to a vector representation. A clustering algorithm, such as the DBSCAN clustering algorithm, can be used to cluster the vectors and filter vectors for VOCs which are outliers (e.g., irrelevant to a substantial topic that concerns many users). After the clustering, embodiments can choose the top clusters in terms of volume and, for each selected cluster, select a single VOC that best captures the user feedback in this cluster. For example, representative VOCs of the top clusters can be selected to be included in a published VOC digest.

To provide this functionality, the disclosed embodiments include improvements to ML processing, providing optimization to density-based clustering algorithms that improves the algorithms' performance and therefore make possible the above-described processes. The optimizations made to ML processing, described in detail below, are technical improvements to ML processing generally. Indeed, these optimizations can be applied to other ML processes in addition to the example VOC processing presented herein. In addition, the disclosed improvements in determining representatives for each VOC cluster leverage the improved ML processing and are distinctly related to the realm of ML-based computing.

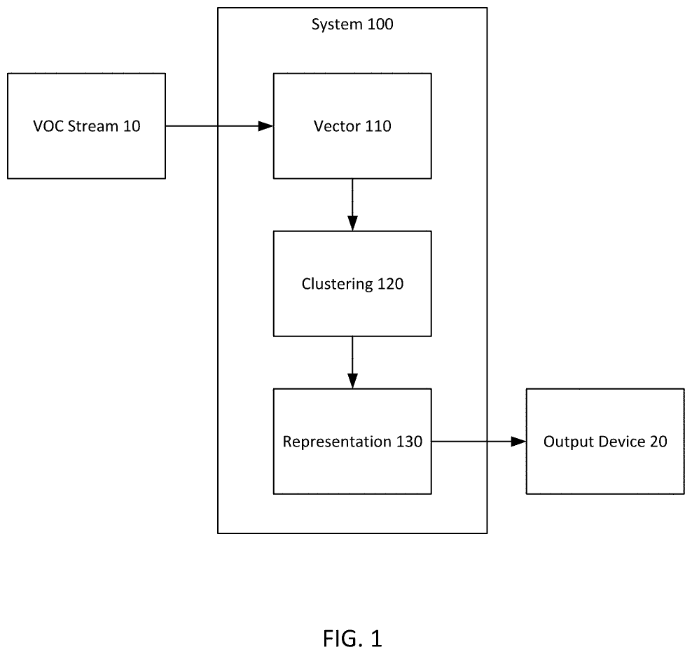

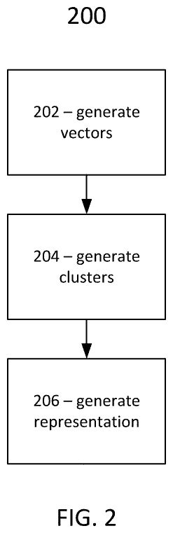

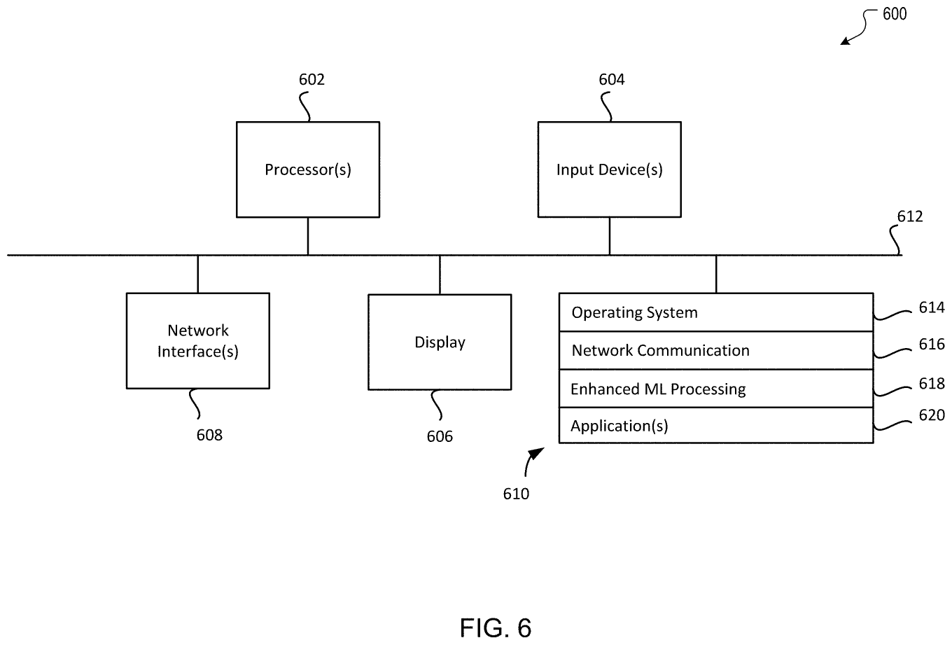

FIG. 1 shows an example VOC processing and reporting system 100 according to some embodiments of the disclosure. System 100 may include a variety of hardware, firmware, and/or software components that interact with one another. For example, system 100 can include vector processing 110, clustering processing 120, and/or representation processing 130, each of which may be implemented by one or more computers (e.g., as described below with respect to FIG. 6). As described in detail below, VOC stream 10 can serve as a source of data for processing to system 100, although other data sources may be possible in other embodiments. The data can include VOC data, such as voice recordings and/or text transcripts thereof. The VOC data can be about one or more topics. Unless VOC stream 10 is provided to system 100 in vector form, vector processing 110 can convert the VOC data into vectors. To understand which topics should go to summarization and/or understand trends, clustering processing 120 of system 100 can process the vectors using ML clustering processes to determine distances between messages that are similar to each other. Representation processing 130 of system 100 can form a representation of the topic(s) identified through the ML processing performed by clustering processing 120. System 100 can provide the results to output device 20, for example for display to a user and/or for further processing. For example, FIGS. 2-5 illustrate the functioning of system 100 in detail.

VOC stream 10, output device 20, system 100, and individual elements of system 100 (vector processing 110, clustering processing 110, and representation processing 120) are each depicted as single blocks for ease of illustration, but those of ordinary skill in the art will appreciate that these may be embodied in different forms for different implementations. For example, system 100 may be provided by a single device or plural devices, and/or any or all of its components may be distributed across multiple devices. In another example, while vector processing 110, clustering processing 120, and representation processing 130 are depicted separately, any combination of these elements may be part of a combined hardware, firmware, and/or software element. Moreover, while one VOC stream 10 and output device 20 are shown, in practice, there may be single instances or multiples of any of these elements and/or these elements may be combined or co-located.

FIG. 2 shows an example VOC processing and reporting process 200 according to some embodiments of the disclosure. System 100 can perform process 200 to process inputs such as VOC data, for example, in order to find relationships between the inputs and provide a representation of the inputs.

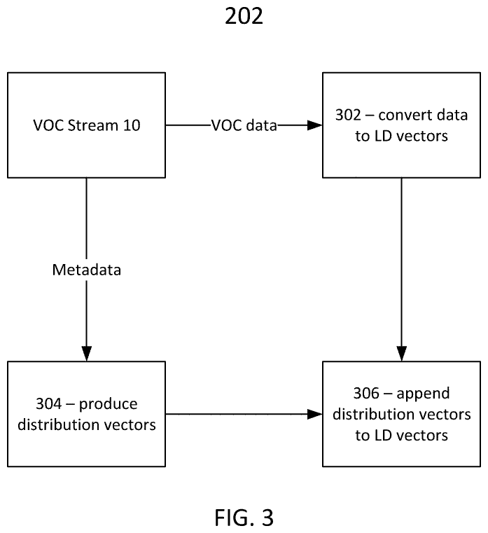

At 202, system 100 (e.g., vector processing 110) can generate a plurality of vectors representing VOC data, other text data, or some other type of data. For example, this can include fetching the text data (e.g., by a batch process) and converting the text data into the plurality of vectors using a transformer network. This can also include enriching at least one of the plurality of vectors based on metadata associated with the text data and/or other features. An example of vector generation is described in detail with respect to FIG. 3 below.

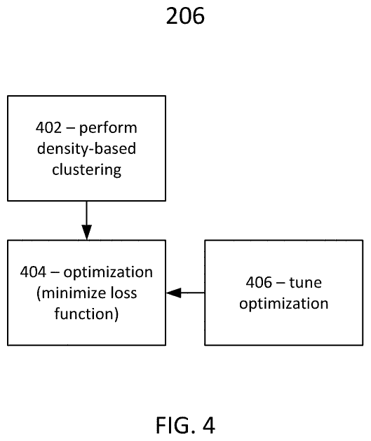

At 204, system 100 (e.g., clustering processing 120) can generate one or more clusters of the vectors. For example, each cluster can be a cluster of at least two (or any other minimal cluster size) of the plurality of vectors generated using a density-based clustering algorithm. Going beyond generic density-based clustering, the generating can include optimizing at least one hyperparameter of the density-based clustering algorithm by minimizing a loss function to increase the clusters' count and decrease the clusters' diameter. An example of cluster generation is described in detail with respect to FIG. 4 below.

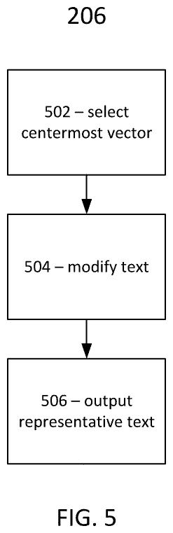

At 206, system 100 (e.g., representation processing 130) can generate a representation of the cluster. For example, this can include selecting a vector closest to a center of the cluster as a representative VOC of the plurality of vectors in the cluster and outputting the representative VOC (e.g., to output device 20). An example of representation generation is described in detail with respect to FIG. 5 below.

FIG. 3 shows an example vector generation process 202 according to some embodiments of the disclosure. In this example, the input data is VOC stream 10 data, including text and metadata, which may be confined to a given period of interest, such as a day or week, in some embodiments. By performing process 202, system 100 can generate a plurality of vectors and can enrich at least one of the plurality of vectors based on the VOC text and metadata, for example, by applying a trained classifier to the VOC text and metadata and appending a distribution vector produced with the trained classifier to at least one of the plurality of vectors.

VOC stream 10 can include, for example, VOC entries generated as user queries, feedback, or as part of a conversation between a user and a representative. The following statements are representative samples of VOC stream 10 entries, although it will be understood that any information may be conveyed in any VOC stream 10 entry:
“It's great for doing wages, but I do not want to pay for Excel just to print off 2 payroll details. Can you help?”
“I want to send the payment link via text, but it only allows me to send via email. The client does not want it sent via email and wants to have it sent via text.”
“Make it so you can set it for a particular client on every invoice if we choose that setting.”
“Program is priced too high for small businesses with minimal income. I wish there were more options or a pay-as-you-go system instead of a one-time monthly fee, especially since sometimes I only print one to two invoices a month.”
“Hi! Would love to be able to set Net 30 invoice due dates for 30 days past the shipping date, rather than 30 days past the invoice date. Thank you.”
“Over the past 6 years of using QB, I haven't faced much issues with renewal. But this year I am really unhappy with the QB service. Usually companies will prefer yearly or half-yearly payment, but QB only offers a monthly option. Very disappointed with the billing service and payment process. Kindly offer a yearly or half-yearly payment option.”

At 302, system 100 (e.g., vector processing 110) can convert each entry in the VOC stream 10 data (e.g., each feedback or review) into a vector. For example, entries can be converted into vectors using the SentenceBERT method or similar techniques. The SentenceBERT method trains a Siamese version of BERT to enable sentence encoding such that semantically similar sentences will result in vectors that proximate in the vector space. In some embodiments, system 100 may filter out some entries prior to conversion, for example selecting only entries having a word count and/or sentences length between some minimum value and some maximum value for conversion. For example, each of the above VOC stream 10 entries may map to a unique sentence embedding (e.g., a vector made up of real numbers) after the processing at 302.

At 304, system 100 (e.g., vector processing 110) can produce distribution vectors for the data entries to be used as enhancements to the vectors produced at 302. This can allow system 100 to leverage the VOC text and metadata to improve the vector representation. For example, VOC feedbacks can include workflow metadata, which can indicate a particular UI element where the feedback was recorded, and/or classification metadata, which can be a label (e.g., user-defined or rule based) applied to at least some VOC feedbacks. To produce distribution vectors using those fields and/or other metadata, system 100 may use a pretrained model. For example, system 100 may have previously trained a multiclass classifier using the feedback text and metadata fields, with a softmax normalization component, to classify to one of the classes in the classification metadata. At runtime, system 100 can input the feedback text and metadata fields into the pretrained model to produce a distribution function over all possible values of the classification field. For example, each of the above VOC stream 10 entries may be classified as belonging to one or more classes (e.g., the first entry may be labeled “payroll,” and the second entry may be labeled “invoicing,” based on their content and/or based on how they were received (e.g., via a payroll troubleshooting conversation vs. an invoicing troubleshooting conversation)). Each class may be mapped to a vector by the processing at 304.

At 306, system 100 (e.g., vector processing 110) can append the distribution vectors from 304 to the vectors from 302. For example, distribution vectors can be appended to the vectors coming from the sentence embedder as one vector. In some embodiments, system 100 may append one hot encoding of the workflow, wherein assuming n distinct values for workflow, a vector of n columns may be appended, with the ith column in the vector having a value of 1 if the current row workflow equals to workflow i and a value of 0 otherwise. By appending this data, system 100 may produce enriched vectors for clustering.

In some embodiments, additional data can be used to enrich the vectors. For example, in some cases, a classification for historical VOC data may be available. System 100 can use these classified records to train a classification ML model, and apply the trained ML model to vectors that have not yet been classified. Such unprocessed vectors can include the vectors in the present data, and these can be provisionally classified by running them through the trained ML model. The provisional classification can be added to the vectors at this stage, so that as they are processed using cluster generation process 204 as described in detail below, they may be clustered into clusters resembling historical examples. For example, as noted above, VOC stream 10 entries may have been previously classified as belonging to one or more classes, which may be reflected in their metadata and used to append vector information representing the class to the vector generated from the VOC entry itself. If VOC stream 10 entries have not been previously classified, they may be processed using an ML model trained on classified VOC entries, and thereby provisionally classified automatically. Such provisional classification can be vectorized at 304 and appended at 306, as described above.

FIG. 4 shows an example cluster generation process 204 according to some embodiments of the disclosure. By performing process 204, system 100 can generate clusters of the vectors produced at 202. Process 204 includes technical enhancements to density-based clustering that improve the performance of density-based clustering algorithms in cases where high cluster density and high cluster count are desirable. This can include the VOC examples presented herein, but is likewise applicable to other high cluster density and high cluster count density-based clustering.

At 402, system 100 (e.g., clustering processing 120) can perform density-based clustering of the plurality of vectors produced at 202 (or any other plurality of vectors, in other embodiments). For example, system 100 can run a DBSCAN algorithm on the vectors. DBSCAN is a density-based method, known to those of ordinary skill in the art, which creates clusters for points which have enough other points in distance less than a given threshold epsilon. DBSCAN also filters points that are not proximate to enough other points, which enables system 100 to filter entries that are not part of a larger topic within the VOC corpus. DBSCAN is used as an example herein, but system 100 may use any known or proprietary density-based clustering algorithm (e.g., any algorithm configured to create clusters for points less than a given threshold epsilon away from one another).

At 404, system 100 (e.g., clustering processing 120) can apply optimization(s) to the density-based clustering, improving the performance of the density-based clustering. For example, on top of the standard DBSCAN procedure, system 100 can use an optimization scheme to search for the best hyperparameters. For example, system 100 can use Hyperopt or a similar algorithm to find the epsilon parameter of the DBSCAN algorithm. In this search, system 100 can maximize the density within each cluster (which may be defined by the maximum cluster diameter/epsilon or by the maximum standard deviation of the distance of each point from the cluster center) and maximize the number of clusters. By applying this optimization, system 100 generates clusters that can provide more relevant groupings of vectors for representation generation (discussed below) or other uses. For example, in the VOC context, maximizing cluster count increases the number of specific feedback topics available, while reducing cluster variance ensures that the feedbacks within a cluster are all relevant to the topic.

Using this optimization, system 100 can maximize a density within the cluster (which may be defined by a maximum cluster diameter/epsilon or by the maximum standard deviation of a distance of each point from a cluster center) and maximize a number of clusters. In other words, system 100 can minimize a loss function to increase clusters' count and decrease clusters' variance. One example of a loss function being minimized can be defined as—(clusters count)+(maximum cluster diameter/epsilon). Another example of a loss function being minimized can be defined as—(clusters count)+(maximum standard deviation of a distance of each point from a cluster center). In general, any loss function that helps to increase clusters count and decrease clusters variance can be used. Examples may include, but are not limited to, (maximum cluster diameter/epsilon)/(clusters count), (maximum standard mean)/(clusters count), (1/clusters count)+maximum cluster diameter/epsilon), 1/(clusters count+maximum standard mean), —(clusters count)+(average cluster diameter/epsilon), and—(clusters count)+(average standard mean).

At 406, system 100 (e.g., clustering processing 120) can tune the optimization processing. In some cases, the tuning can be performed occasionally or periodically, and need not be part of every instance of cluster generation, as shown. For example, some embodiments may tune the optimization processing each week. The tuning may include tuning the hyperparameter, for example minimizing using Hyperopt. When tuning is performed, system 100 can use Hyperopt to get a new epsilon parameter for the DBSCAN algorithm. If the epsilon has changed (e.g., due to a change in the nature of the data coming in as compared with the last time the algorithm was tuned), the new epsilon can be applied moving forward to ensure the clustering algorithm continues to maximize the density within each cluster and maximize the number of clusters.

FIG. 5 shows an example representation generation process 206 according to some embodiments of the disclosure. By performing process 206, system 100 can select one VOC feedback that represents the VOC topic of the cluster from which it is drawn. Process 206 is an extractive, rather than generative, process that can base the representative text on actual cluster content, ensuring it is truly representative. Process 206 is uniquely suited to the realm of ML-based computing as it generates representative text for data that is clustered in this context. Moreover, process 206 leverages the improvements to clustering described above to provide even more accurate representations, because the clusters themselves can be understood to be well-grouped and specific.

At 502, system 100 (e.g., representation processing 130) can select a centermost vector in a cluster as representative. For example, system 100 can select a vector that is closest to the center of the cluster in terms of Euclidean distance. In some embodiments, system 100 can always select the closest vector, regardless of the content of its associated text. In other embodiments, system 100 can analyze the text associated with the closest vector to identify spelling and/or grammar mistakes and only select the closest vector if it is mistake-free. In this case, if a mistake is present, system 100 may move to the next-closest vector and repeat the spelling and/or grammar analysis, continuing through all vectors until a mistake-free example is found. If all text contains mistakes, system 100 may revert to selecting the nearest vector to the center.

At 504, system 100 (e.g., representation processing 130) can modify the text associated with the vector selected at 502, thereby producing a text string that can serve as representative text for the cluster. In some embodiments, system 100 can fix one or more spelling and/or grammar errors using known or proprietary spelling and/or grammar checking processing. In addition and/or alternatively, system 100 can remove and/or replace some text. For example, system 100 can apply a plurality of regular expressions to the representative text, named-entity recognition (NER), or perform some other process, to identify words to be masked out of the text. Such words can include profanity and/or user-identifying data such as email addresses, phone numbers, account numbers, names, etc. Words to be masked out may be simply deleted or may be replaced by nonce words or other text.

At 506, system 100 (e.g., representation processing 130) can output the representative text generated at 504. The representative text can be provided to any output device(s) 20 for any purpose. For example, system 100 may send the representative text to a team of professionals that works on issues related to the topic of the cluster (e.g., via a slack channel, email, etc.), may store the representative text in a database or other memory, may provide the representative text to some other computing process for further processing, etc.

FIG. 6 shows a computing device 600 according to some embodiments of the disclosure. For example, computing device 600 may function as system 100 or any portion(s) thereof, or multiple computing devices 600 may function as system 100.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

Enhanced ML processing 618 may include the system elements and/or the instructions that enable computing device 600 to perform the processing of system 100 as described above, including one or more of vector processing 110, clustering processing 12, and/or representation processing 130. For example, enhanced ML processing 618 may provide the above-described optimizations to density based ML clustering algorithms that allow clustering processing 120 to outperform standard density based ML clustering for the VOC clustering (and/or other) task(s). Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, while the enhancements to ML clustering are applied to form clusters of VOC data herein, those of ordinary skill in the art will appreciate that the same enhancements can be applied to ML clustering of other types of data. Additionally or alternatively, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by a processor, a plurality of vectors representing text data;
generating, by the processor, a cluster of at least two of the plurality of vectors using a density-based clustering algorithm, the generating comprising optimizing at least one hyperparameter of the density-based clustering algorithm by minimizing a loss function to increase a cluster count and decrease a cluster variance;
selecting, by the processor, a vector closest to a center of the cluster as a representative text of the at least two of the plurality of vectors; and
outputting, by the processor, the representative text.

2. The method of claim 1, further comprising generating, by the processor, the plurality of vectors, the generating of the plurality of vectors comprising:
fetching, by the processor, the text data; and
converting, by the processor, the text data into the plurality of vectors using a transformer network.

3. The method of claim 1, further comprising generating, by the processor, the plurality of vectors, the generating of the plurality of vectors comprising enriching at least one of the plurality of vectors based on metadata associated with the text data.

4. The method of claim 3, wherein the enriching comprises applying a trained classifier to the metadata and appending a distribution vector produced with the trained classifier to at least one of the plurality of vectors.

5. The method of claim 1, wherein the loss function is defined as—(cluster count)+(maximum cluster diameter/epsilon).

6. The method of claim 1, wherein the loss function is configured to maximize a density within the cluster, defined by a maximum cluster diameter/epsilon), and maximize a number of clusters.

7. The method of claim 1, further comprising applying, by the processor, a plurality of regular expressions to the representative text to modify the representative text prior to the outputting.

8. The method of claim 1, further comprising modifying, by the processor, the representative text prior to the outputting, the modifying comprising at least one of fixing a spelling error, fixing a grammatical error, masking a profanity, and masking user-identifying data.

9. A system comprising:
a processor; and
a non-transitory memory in communication with the processor storing instructions that, when executed by the processor, cause the processor to perform processing comprising:
receiving a plurality of vectors representing text data;
generating a cluster of at least two of the plurality of vectors using a density-based clustering algorithm, the generating comprising optimizing at least one hyperparameter of the density-based clustering algorithm by minimizing a loss function to increase a cluster count and decrease a cluster variance;
selecting a vector closest to a center of the cluster as a representative text of the at least two of the plurality of vectors; and
outputting the representative text.

10. The system of claim 9, wherein the processing further comprises generating the plurality of vectors, the generating of the plurality of vectors comprising:
fetching the text data; and
converting the text data into the plurality of vectors using a transformer network.

11. The system of claim 9, wherein the processing further comprises generating the plurality of vectors, the generating of the plurality of vectors comprising enriching at least one of the plurality of vectors based on metadata associated with the text data.

12. The system of claim 11, wherein the enriching comprises applying a trained classifier to the metadata and appending a distribution vector produced with the trained classifier to at least one of the plurality of vectors.

13. The system of claim 9, wherein the loss function is defined as—(cluster count)+(maximum cluster diameter/epsilon).

14. The system of claim 9, wherein the loss function is configured to maximize a density within the cluster, defined by a maximum cluster diameter/epsilon, and maximize a number of clusters.

15. The system of claim 9, wherein the processing further comprises applying a plurality of regular expressions to the representative text to modify the representative text prior to the outputting.

16. The system of claim 9, wherein the processing further comprises modifying the representative text prior to the outputting, the modifying comprising at least one of fixing a spelling error, fixing a grammatical error, masking a profanity, and masking user-identifying data.

17. A method comprising:
receiving, by a processor, a plurality of vectors;
generating, by the processor, a cluster of at least two of the plurality of vectors using a density-based clustering algorithm, the generating comprising optimizing at least one hyperparameter of the density-based clustering algorithm by minimizing a loss function to increase a cluster count and decrease a cluster variance;
selecting, by the processor, a vector closest to a center of the cluster as a representative vector; and
outputting, by the processor, the representative vector.

18. The method of claim 17, wherein the loss function is defined as—(cluster count)+(maximum cluster diameter/epsilon).

19. The method of claim 17, wherein the loss function is configured to maximize a density within the cluster, defined by a maximum cluster diameter/epsilon, and maximize a number of clusters.

20. The method of claim 17, further comprising generating, by the processor, the plurality of vectors, the generating of the plurality of vectors comprising:
fetching, by the processor, data; and
converting, by the processor, data into the plurality of vectors using a transformer network.
